(19) United States
(12) Patent Application Publication
(10) Pub. No.: US 2010/0131327 A1
(43) Pub. Date: May 27, 2010

(54) COLLABORATIVE METHOD AND ITS IMPLEMENTATION SYSTEM FOR A TRUST-BASED BUSINESS COMMUNITY

(75) Inventors: Wenwey Hseush, Taoyuan County (TW); Te-Hsiang Liao, Taipei City (TW); Shih-Chang Hsu, Taipei City (TW); Song Yuan, Beijing (CN)

Correspondence Address: YH Chan, 42 Pin Oaks Drive, Phoenixville, PA, 19460, US

(73) Assignee: eBizServe Technology Limited, Hong Kong (HK)

(21) Appl. No.: 12/277,312

(22) Filed: Nov. 25, 2008

(51) Int. Cl. G06Q 10/00; G06Q 99/00

(52) U.S. Cl. 705/9; 705/300

(57) ABSTRACT

A collaborative method and its implementation system for a trust-based business community, enables a business person, who behaves as a function of a corporation, to invite his/her business partners to form a trust-based business community. Through this method and system, the business person can create, conduct and commit/abort a collaborative activity with their business partners to achieve a business objective. This method and system are also defined as a participation mechanism, which effectively addresses the mixed situations of competition and collaboration. Based on legal-binding invitation and principle of good faith, the system can support the establishment of such a TBC, thus providing a good collaboration platform for the companies to do business effectively and efficiently in today's business world. The key application of this method and system is for Collaborative Sourcing and Product Development, which helps a buyer to source and develop products with multiple suppliers in a single process, wherein some suppliers may be competitive to each others and some are collaborative to each others.

### BACKGROUND OF THE INVENTION

The present invention relates generally to a function of collaboration, communication and interaction based on computer network platform, and more particularly to a method and system designed for an Internet-based trust-based business community of suppliers and buyers to conduct collaborative activities.

With the trend of globalization and development of advanced Web technologies, Internet applications evolve from information sharing, transaction-based e-commerce to community-based collaborative applications. However, most community-based platforms are shaped for social network (i.e. Facebook and MySpace) rather than business-to-business collaborations. Those social network-based platforms are not intended to form trusted communities where members are responsible and liable for their actions and behaviors, and therefore those platforms are often unsuitable for important business activities.

In view of the operating modes of the enterprises, e-commerce is categorized into business-to-business (B2B) and business-to-consumer (B2C). Most B2B e-commerce applications deliver the functions of sharing information and conducting transactions either through direct message exchange, such as RosettaNet (i.e. B2B Integration) or exchange hubs (i.e. e-marketplace or exchange). The applications of B2B collaboration or supply chain collaboration further enable upstream, midstream and downstream businesses to collaborate as an integrated supply chain. The approach has been proven as an effective way for enterprises to utilize supply chain resources and maximize supply chain performance, in order to improve their corporate competitiveness. However, most current B2B collaboration applications are operated in a closed environment and adopt only proprietary processes, thus leading to non-scalable and inflexible collaborative relationships and operations with business community partners. Community-based platforms are incorporated to move towards e-commerce in a collaborative manner, so as to utilize effectively the business resources and optimize the business performance. Hence, the relevant industry operators shall make efforts to learn how to optimize the application of e-commerce in the businesses.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The collaborative business method and implementation system of the present invention is intended for the application of trust-based business community under a computer network (e.g. Internet and Web). The method and system enable to create a trustworthy business community for a Business Persons (BP) who works as a specific role for a specific corporation, and establish a trustful partner through legally-binding invitation process.

The collaborative business method and implementation system enables a Business Persons (BP) to create a collaborative activity and invite some partners to participate it in a trust-based business community. Through the collaborative activity, the participants can attend various business activities and reach their business objectives.

One of key applications for this method and system is intended for Collaborative Sourcing and Product Development, which helps a buyer to source and develop products with multiple suppliers in a single process, wherein some suppliers may be competing with each other and some are collaborating with each others.

This method and system provide a collaborative method, of which the system serves as a platform for implementation of the model and a method for implementation of the platform.

In sum, the present invention is designed to provide an improved structure and method of expected performance, novelty and applicability; for the purpose of deeper understanding of the aforementioned purposes, technical means and efficacies, the present invention is described below with reference to the accompanying drawings.

### BRIEF DESCRIPTION OF THE DRAWINGS

FIG. 1: system framework view of the present invention.

FIG. 2: schematic view of a preferred embodiment of the present invention.

FIG. 3: flow process view of Creating Business Persons (BP) of the present invention.

FIG. 4: login process view of the present invention.

FIG. 5: schematic view of partner interface of the present invention.

FIG. 6: schematic view of activity interface of the present invention.

FIG. 7: flow process view of creating business activity of the present invention.

FIG. 8: schematic view of preferred embodiment of a window of the present invention.

FIG. 9: schematic view of preferred embodiment of a window of the present invention.

FIG. 10: schematic view of preferred embodiment of a window of the present invention.

### DETAILED DESCRIPTION OF THE INVENTION

The present invention includes a method based on a Trust-Based Business Community (TBC) model, and a system that implements the method.

This invention assumes trust relationships (1) legally enforceable and (2) trustworthy to each other (i.e. “A trusts B” implies “B trusts A”). In the business world, such assumptions are true and any distrusted behaviors may result in serious legal penalty.

The invented method is designed for corporate users to conduct business with partners in a trust environment. Trust-Based Business Community (TBC) model is defined as follows:
a. A Trust-Based Business Community (TBC) is a group of trusted Business Persons (BP) formed by invitations to conduct meaningful Collaborative Activities. Every Business Person is trusted and invited by at least one Business Person or the initiator of the community. Whether a business person is “trusted” solely depends on whether the inviting party can trust the person or not. It is the sole responsibility of the inviting party to verify the trust relationship.
b. A Business Person is an individual who works as a specific role (function) for a specific corporation.
c. A Business Person's status is invalidated as soon as he/she changes his current position.
d. It is the responsibility of every Business Person to reveal his/her job position change to other Business Person in the TBC.
e. Once a Business Person is invalidated, he/she may not be trustworthy. The new trust state of the individual is determined and should be reviewed by his/her Business Persons.
f. A TBC starts with an initiator Business Person who invites other trusted Business Persons from the real business world. Any Business Person in the TBC can then invite more trusted Business Persons. This trust-based invitation process produces a group of trusted Business Persons, which forms a trust-based business community.
g. An invitation is a message-based process. An invitation is initiated by a Business Person and accepted or denied by a second Business Person.
h. The fact that A trusts B implies that B trusts A. It is the sole responsibility of the inviting party to verify the trust relationship.
i. The (directly) invited Business Person and the inviting Business Person are known as Partners. The fact that A is a partner of B implies that B is a partner of A. Any indirect invitation does not establish a partnership. For example, A invites B and B invites C. A and B are partners. B and C are partners. But, A and C may NOT be partners. The fact that A trusts B as B trusts C does not imply that A trusts C.
j. A Business Person can terminate a partnership by uninviting the partner. A partnership can only be terminated successfully only if no on-going activities exist.
k. A Collaborative Activity is an activity created by a Business Person (called the Chairman or Creator), who invites one or more Business Persons as the participants to play interactively according to the rules and processes pre-defined in the Collaborative Activity. Any participant can invite his/her partners to participate the activity. Two participants of a Collaborative Activity may or may not be partners.
l. An invitation to a Collaborative Activity is a message-based process, which is initiated by a participant and accepted or denied by his/her partners.
m. A Collaborative Activity starts when the chairman creates the activity, and ends when the chairman commits or aborts the activity.
n. When a Business Person is invalidated, he/she can not access to all Collaborative Activities that he/she created or participated.

Besides the invitation process, the key mechanism that delivers a collaborative and competitive real-world scenario is the refinement of participating modes. The Creator of a Collaborative Activity can specify the participating mode for the participant once the invitation has been accepted. There are two participating modes: Shared and Exclusive. A Shared participant knows the existence of all participants (both Shared and Exclusive) and is able to see all the actions or data issued from all participants (both Shared and Exclusive). An Exclusive participant knows the existence of only Shared participants and is able to see the actions or data only from Shared participants. An Exclusive participant does not know the existence of any other Exclusive participant, and is not able to see actions or data from any other Exclusive participant. The interaction of participants is shown in the table below.

| Knowledge | Shared | Exclusive |
|---|---|---|
| Of Existence | Participant | Participant |
| Shared | Yes | Yes |
| Participant(B) | | |
| Exclusive | Yes | No |
| Participant(D) | | |

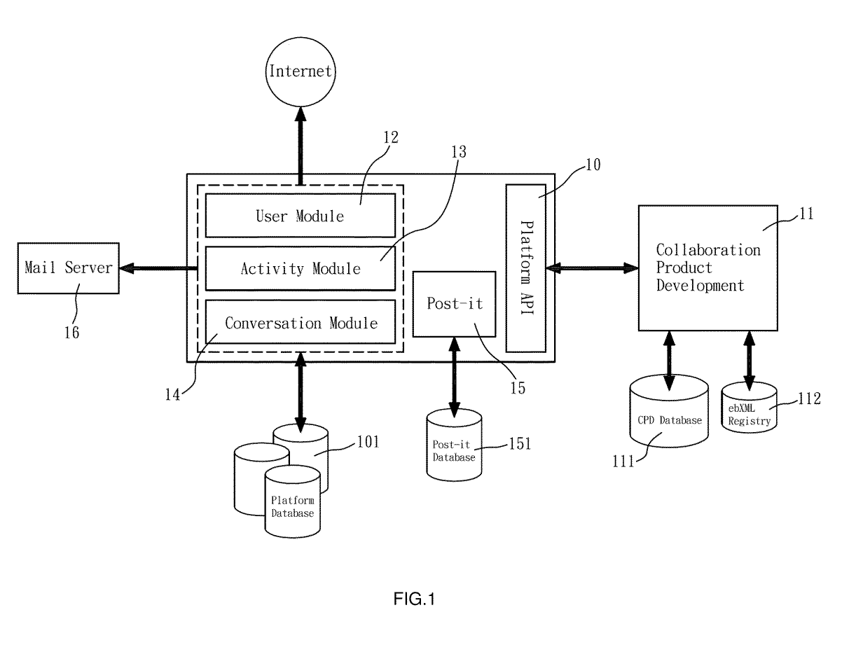

One of the applications for this method and system is Collaborative Sourcing and Product Development. Using this method and system, a buyer can conduct sourcing and product development as a single task with multiple suppliers. A buyer can create his/her trust-based business community by inviting his/her trusted suppliers to the community. Whenever he/she desires to source and develop products from several suppliers, he/she creates a Collaborative Activity and invites several potential suppliers to participate in. When the suppliers invited to an activity are competitive to each others, they are invited as Exclusive mode participant. Referring to FIG. 1, the system for implementation of the collaborative business model comprises: a platform of application protocol interface (Platform API) 10, Partner Module 12, Activity Module 13, Conversation Module 14, Post-it Module 15 and a Collaborative Application Module 11.

Platform API 10 delivers a communication protocol interface among Partner Module 12, Activity Module 13, Conversation Module 14, Post-it Module 15 and Collaborative Application Module 11.

Partner Module 12 is responsible for creation of business partners, management of business partners' information and other invited business partners/or message management of business partners.

Activity Module 13 is responsible for creating and managing the business activities, participating in the business activities created by other business persons (BP), searching/screening the business activities and/or viewing historical message related to the business activities.

Conversation Module 14 is responsible for real-time message communication among business persons (BP) when participating in the collaborative business activities.

Of which, the Partner Module 12, Activity Module 13 and Conversation Module 14 further comprise a platform database 101, allowing for data access by Partner Module 12, Activity Module 13 and Conversation Module 14.

Post-it Module 15 is responsible for implementing the notes and remarks during collaborative application. It further comprises Post-it database 151, allowing for data access by Post-it Module 15.

The Collaborative Application Product Module 11 may, via the help of Internet or Intranet, conduct data transmission and access between Platform API 10 and Partner Module 12, Activity Module 13, Conversation Module 14 and Post-it Module 15 while serving as the communication protocol interface. The rule of proposed product development is preset by the Collaborative Application Product Module 11, and a business client is delivered to set the business applications of business logic depending on business demands. Furthermore, it comprises a CAP Database 111, allowing for data access among Collaborative Application Product Modules 11.

The Collaborative Application Product Module 11 further comprises ebXML Registry 112, which delivers an interface to Business Persons (BP) for integrating their own data when participating in the collaborative business applications.

This system is also responsible for sending information to the business client by an e-mail through a mail server 16.

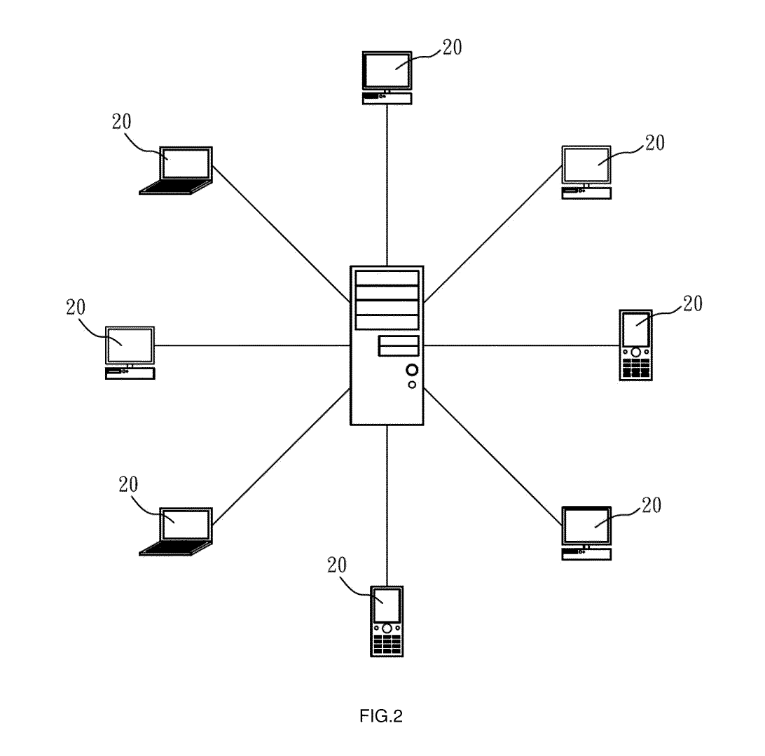

Referring to FIG. 2—another preferred embodiment of the system of the present invention, the business client can access to the collaborative business system through Internet Explorer by any electronic device 20 or equipment, such as: desktop computer, notebook computer, PDA and mobile phone, etc, whichever can linked to the Internet.

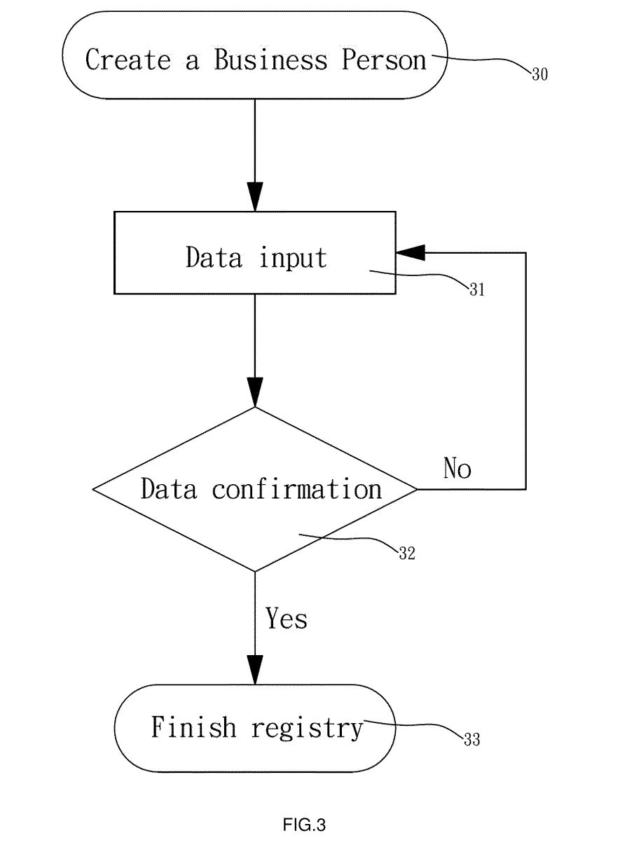

The method and system of the present invention refer to a graphical and literal windowing operational interface or a combined operational interface. When the business client accesses to the collaborative business system through Internet Explorer, the first thing is to obtain a group of account and password, of which the account allows to set an email address, but not limited to an email address; the password may be composed of English letters and figures. From the very beginning, the system provides the registry mode of business behaviors conducted by the business individuals, persons and personal studios as well as the registry mode of corporation account; referring to FIGS. 1, 3, through the operating interface delivered by the Partner Module 12 of the system, users are allowed to Create Business Persons (BP) 30 and conduct data input 31, and then implement finishing registry 33 procedure after data confirmation 32; if data confirmation 32 is not yet completed, the system will require the business client to conduct data input 31 again and fill in unfinished information or field, until the system conducts data confirmation 32 and finishing registry 33 procedures. The information confirmed by the data delivery system include but not limited to the names (of companies or individuals), email addresses, liaison persons and passwords; after completion of finishing registry 33 procedure, the system feeds back a confirmation email to the email address delivered by the business client, who receives the email and starts the account and password.

If the business client Creates Business Persons (BP) 30 by the registry mode of corporation account, the corporation account allows to manage the business individuals and BP according to the operational interface delivered by the Partner Module 12, including but not limited to: setting of authority, agency of business individuals, deletion and replacement, etc.

If the business client Creates Business Persons (BP) 30 by the registry mode of business behaviors of business individuals, persons and personal studios, it is possible to manage the personal information according to the operational interface delivered by the Partner Module 12, including but not limited to: revision of information.

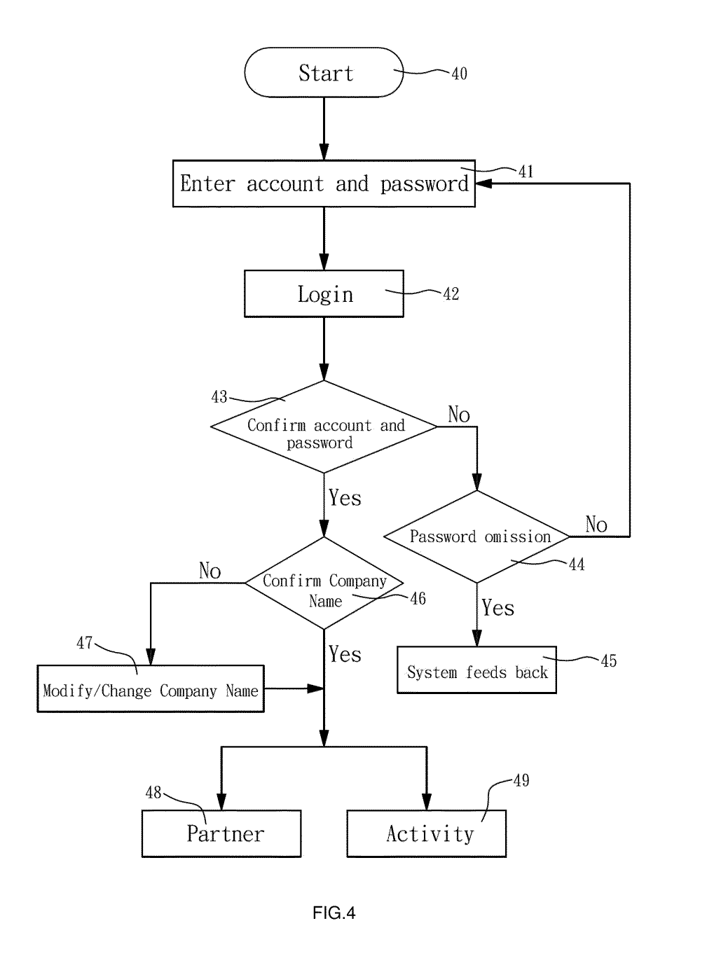

Referring to FIGS. 1, 4, when the business client obtains the registered account and password, he/she can link an electronic device to the system through the Internet Explorer, and login the system with this group of account and password; a starting window is available with two login modes. As mentioned above, the login procedures are performed with the corresponding account and password obtained by the business client:

Start 40: select start or entry button, the system will open another account and password entry window;

Enter account and password 41: enter account and password in the window opened by the preceding step;

Login 42: after entering the account and password, select login button;

Confirm account and password 43: judge the account and password through the system's Partner Module 12; the error of password corresponding to the account may be caused by two conditions: entry negligence(upper and lower cases of English letters not switched, or keying error): in such case, re-enter in the password field and then select login button; password omission 44: select password omission button in the original window, then the system feeds back 45 the password of corresponding account to the email box registered by the business client, so as to obtain the correct password;

Confirm Company Name 46: after entering correctly the aforementioned account and password, the system will open a company name confirmation window for selection by the business client; if the business client has resigned from original company, or original company has changed its name, select “No” button, then the window is switched to the webpage of Modify/Change Company Name 47, and provides the business client with “modification” and “change” options. Meanwhile, the window provides a field for entering new company name by the business client, who may select “submission” button after completion of entry, and then log into the window generated by the next step; if the business client is still at original company, select “Yes” button and then log into the window generated by the next step;

Partner 48/activity 49: log into this window after completion of aforementioned steps; the Partner Module 12 of system in the window manages the “partner” and provides the window interface, whilst the Activity Module 13 manages “activity” and provides the window interface; the window provides the switching function for the business client to select freely the “partner” or “activity” interface.

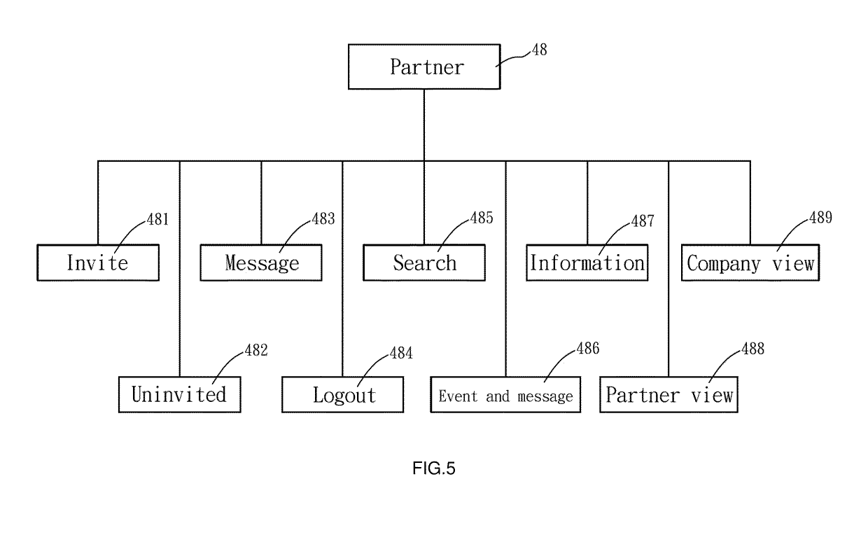

Referring to FIG. 5, the interface of partner 48 includes but not limited to: invite 481, uninvited 482, message 483, logout 484, search 485, event and message 486, information 487, partner view 488 and/or company view 489 buttons, which are functionally described below:

Invite 481: if selecting this button, the system will open a new window by the Partner Module 12, wherein the window interface include but not limited to the following functions: name of the invitee, company name, input of email box field, search of registered company name, input/invite buttons of inviter's self-description field; users can invite the other party if selecting Invite button after completion of entry; and, the system will send a message to the invitee, and confirm if the invitation is successful after the invitee gives a feedback for acceptance or refusal; if the invitee accepts the invitation, he/she will become a business partner of the inviter; otherwise it indicates the invitee is not intended to become a business partner of the inviter;

Uninvite 482: select the invited business partner from the Partner 48 window interface, click Uninvite button to remove the partner from the Partner 48 window through the Partner Module 12; it is imperative that the partner has not attended the activity created by the inviter before being uninvited, or has been removed from the list of attendee by the inviter;

Message 483: select the invited business partner from the Partner 48 window interface, click Message button to open another window, which includes but not limited to: subject and message fields; the business client can write subject and the message to be told, and then click Notify button, so the message can be sent to the business partner via mail server 16 by the Partner Module 12;

Search 485: the business client clicks Search button in the Partner 48 window interface to open another window, which is available with an entry field for entering the field or character string to be searched; at the same time, it provides the settings of search conditions, including but not limited to nickname, company, last name, first name and Boolean operation(and, or, not); the system enables the Partner Module 12 to implement these functions, helping the search of many invited business partners in the Partner 48 window;

Event and Message 486: in the Partner 48 window interface, the business client receives the sent messages, or some procedures implemented by the business client, e.g.: creation of activity or invitation of the partner, etc; then, the Post-it Module 15 is responsible for implementing the notes and remarks, and then reminding of having received new events or messages; the business client can open another window by clicking Event and Message button; the window includes but not limited to: event interface and message interface, so the business client can select to view the event interface, which provides the settings of screening conditions, including but not limited to: all, notify, receive, accept, reject, invite, uninvite, update, update company, overdue, create, participate, un-participate, commit and/or abort, which are intended to shorten the time of viewing events and displaying the events of the same conditions. The displayed field includes but not limited to: mark field, time of event, type of event (e.g. conditions set as mentioned before)and/or information(description of event); after viewing the new events, the business client may remove the mark of new event by clicking “mark as done” button; furthermore, the business client may select to view the message interface, which provides the settings of sequence including but not limited to: time, sender and/or subject; at the same time, the field displayed on the interface includes but not limited to: mark field, time of message, sender, subject and/or information(description of messages); the business client can then click the subject to open another window displaying the details of the message; after viewing the details, the business client may close the window by clicking “Close” button, or cancel this message by clicking “Cancel” button;

Information 487: the Partner 48 window interface provides the functions of viewing the information of the business client and successfully invited business partner; the business client may click Information button or click the photos in the display field uploaded by the partner, then the system function is implemented by the Partner Module 12, allowing to view the details; another window will be opened after clicking; this window includes several options but not limited to: information, personal, company and/or note; of which, the “information” display and input include but not limited to: e-mail and account, company name, user name, job title, time zone, set password and/or upload photos; the “personal” display and input include but not limited to: contact number, address, city, state and country; the “company” display and input include but not limited to: department, contact number, fax number, address, city, state and country; the “note” display and input include the description field; after completion of entering, modification or setting of the aforementioned fields, save new setting by clicking “Save” button on the window, or cancel this window by clicking “Cancel” button. The information of business partner is only for viewing, but cannot be written or modified, and the password is hidden;

Partner View 488: the Partner 48 window interface provides the business client with the functions of selecting partner view; then the system function is implemented by the Partner Module 12, namely, the photos uploaded by the business partner will be sequenced on top priority, followed by status, user name, company name, activity and channel;

Company view 489: the Partner 48 window interface provides the business client with the functions of selecting company view; the system function is implemented by the Partner Module 12, namely, the status of the business partner will be sequenced on top priority, followed by company name, user name, job title, activity and channel;

Logout 484: the Partner 48 window interface provides the business client with a function of exiting from this window by clicking logout button.

The aforementioned Partner 48 window interface includes several display fields but not limited to photo, status, user name, company name, job title, activity and/or channel.

Of which, the photo field displays the photos uploaded by the business partner; the status displays the invited status of business partner—off-line or on-line status; the user name, company name and job title fields display the real name of business partner, real company name and actual job title; the activity field displays the business activity created by the business partner; and the channel field shows if the business partner provides Internet telephone(skype).

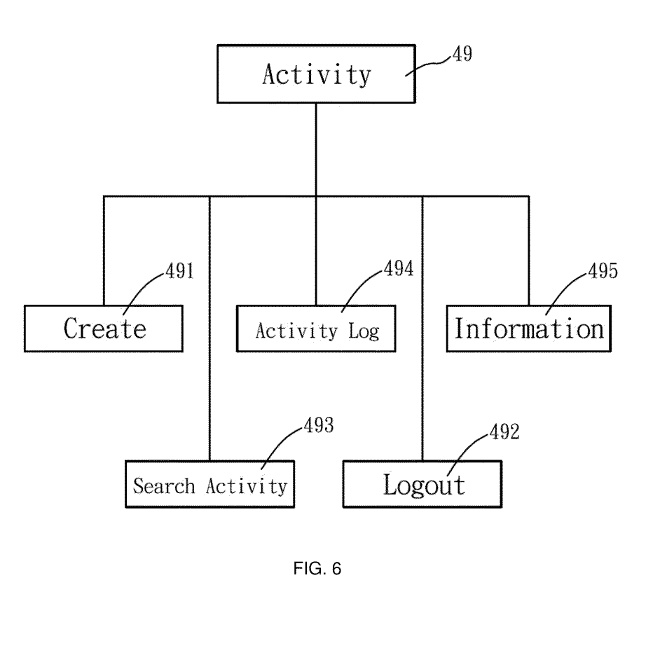

Referring to FIG. 6, the activity 49 window interface includes but not limited to: Create 491, Logout 492, Search Activity 493, Activity Log 494 and/or Information 495 buttons, which are functionally described below:

Create 491: if clicking Create button in the Activity 49 window interface, a business activity could be established through the Activity Module 13 of the system, with the details of the business activity described in the subsequent paragraphs;

Search Activity 493: the business client can open another window if clicking Search button in the Activity 49 window interface; this window provides an entry field for entering the character or character string of the activity to be searched; the system enables the Activity Module 13 to implement this function, helping the search of business activities created in the Activity 49 window; the business activity is shown as created by the business client, inviter and/or invitee;

Activity Log 494: in the Activity 49 window interface, the business client receives the sent messages, or some procedures implemented by the business client, e.g.: requiring the partner to participate in the created business activity or cancelling the partner to participate in the created business activity, or the partner is invited by the remote inviter to participate in the created business activity as well as creation of activity, etc; the Activity Module 13 of the system is responsible for implementing this function, and then reminding of having received new logs or messages, so the business client can open another window by clicking the Activity Log button; this window includes but not limited to: history interface and commit/abort interface; the business client may select to view the history interface, which provides the setting of the screening conditions, including but not limited to: all, create, participate, un-participate, request, block, replacement and remove, which are intended to shorten the time of viewing history events and displaying the history events of the same conditions. The displayed field includes but not limited to: mark field, time of history event, type of log (e.g. conditions set as mentioned before)and/or information(description of log); after viewing the new history log, the business client may remove the mark of new log by clicking “mark as done” button; furthermore, the business client may select to view the commit/abort interface, which provides the settings of sequence including but not limited to: all, status, activity, creator and type; at the same time, the field displayed on the interface includes but not limited to: mark field, time, name of activity, creator, company and/or type; after viewing the logs of new commit or abort, the business client may remove the mark of new log by clicking “mark as read” button;

Information 495: the Activity 49 window interface provides the functions of viewing the information of the business client and the business partner in the business activity; the business client may click Information button or click the pull-down key to display the photos in the field uploaded by the business partner; then the system function is implemented by the Partner Module 12, allowing to view the details; another window will be opened after clicking; this window includes several options but not limited to: information, personal, company and/or note; of which, the “information” display and input include but not limited to: e-mail and account, company name, user name, job title, time zone, set password and/or upload photos; the “personal” display and input include but not limited to: contact number, address, city, state and country; the “company” display and input include but not limited to: department, contact number, fax number, address, city, state and country; the “note” display and input include the description field; after completion of entering, modification or setting of the aforementioned fields, save new setting by clicking “Save” button on the window, or cancel this window by clicking “Cancel” button. The information of business partner is only for viewing, but cannot be written or modified, and the password is hidden;

Logout 492: the Activity 49 window interface provides the business client with a function of exiting from this window by clicking logout button.

The aforementioned Activity 49 window interface includes several display fields but not limited to mark field, pull-down key, representative photo of the activity, activity name, option button of “acceptance” and “refusal” (this is implemented by the system and displayed only when the business client is invited by the remote inviter to participate in the created activity), type of activity, etc; while the created business activity will be displayed in the field.

Of which, the mark field can be divided into the activity mark created by the business client, blocked activity mark, activity mark created by the inviter and invitee.

The blocked activity mark is generated owing to the fact that the business activity participated or created by original company is blocked due to the change of business client's company name; if the company name is modified during login, the business activity created or participated will not be blocked.

The business client may view the participants (including the business partner and business client) of this business activity by clicking the pull-down key specific to the business activity; the field of participants displays the photos uploaded by the business partner, off-line or on-life status of business partner, business partner name and/or company name.

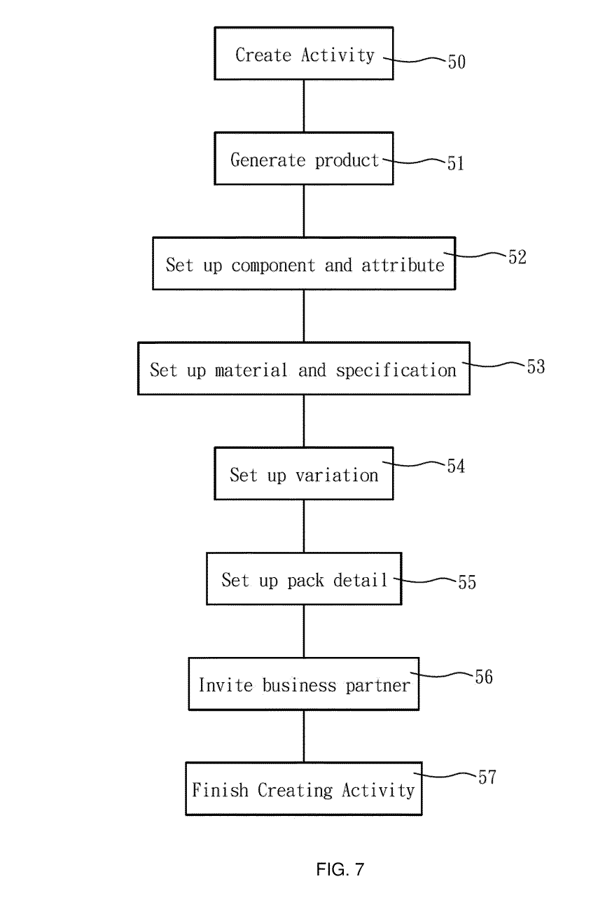

Referring to FIG. 7, after clicking Create Activity 50 in the Activity 49 window interface, the Activity Module 13 of the system will access to the Collaborative Application Module 11 and its Database 111 through Platform API 10 and open another window, while setting a series of business activity planning and conditions, including but not limited to: generate product phase 51, set up component and attribute 52, set up material and specification 53, set up variation 54, set up pack detail 55 and/or invite business partner 56, with the details described below.

Generate product phase 51: the setting in this phase includes but not limited to: set the program name, type, icon, product name, description, attachment and/or category;

Set up component and attribute 52: the setting in this phase includes but not limited to: set the components of product and their attributes, which have different definitions due to the product category, for example, the components of clothes comprise yarn, thread, cloth, molding, pressing, sewing, weaving methods, styles and customers;

Set up material and specification 53: the setting in this phase includes but not limited to: set the materials for the components of product and their attributes, and set the specification and/or manufacturing process, which have different definitions due to the product category, for example, the components of clothes comprise the type, size and material of yarn, thread and cloth, as well as molding, pressing, sewing, weaving methods and setting of styles;

Set up variation 54: the setting in this phase includes but not limited to: set the changing styles, sizes and colors of products, etc, which have different definitions due to the product category, for example, the styles of male, female or neutral style; big, medium and small sizes, or the quantified size; and the colors divided by universal color cards;

Set up pack detail 55: the setting in this phase includes but not limited to: description of instruction, mode of payment, type of currency, shipping mode, delivery date, contrast of sizes and/or setting of styles and sizes;

Invite business partner 56: the setting in this phase includes but not limited to: invite the business partner to participate in the created activity program, set the power of partners participating in this program, and set the shared or exclusive modes of partners participating in this program.

Create activity 57 is finished after the aforementioned phases are implemented gradually; during the process of Create Activity 50, Generate Product Phase 51 must be finished to provide preliminary basis for creation of business activity program, whilst the contents set in other phases may not be finished, and can be skipped over to the next phase, or even only the contents set in Generate Product Phase 51 are finished, but the business activity program is still created and displayed in the Activity 49 window interface.

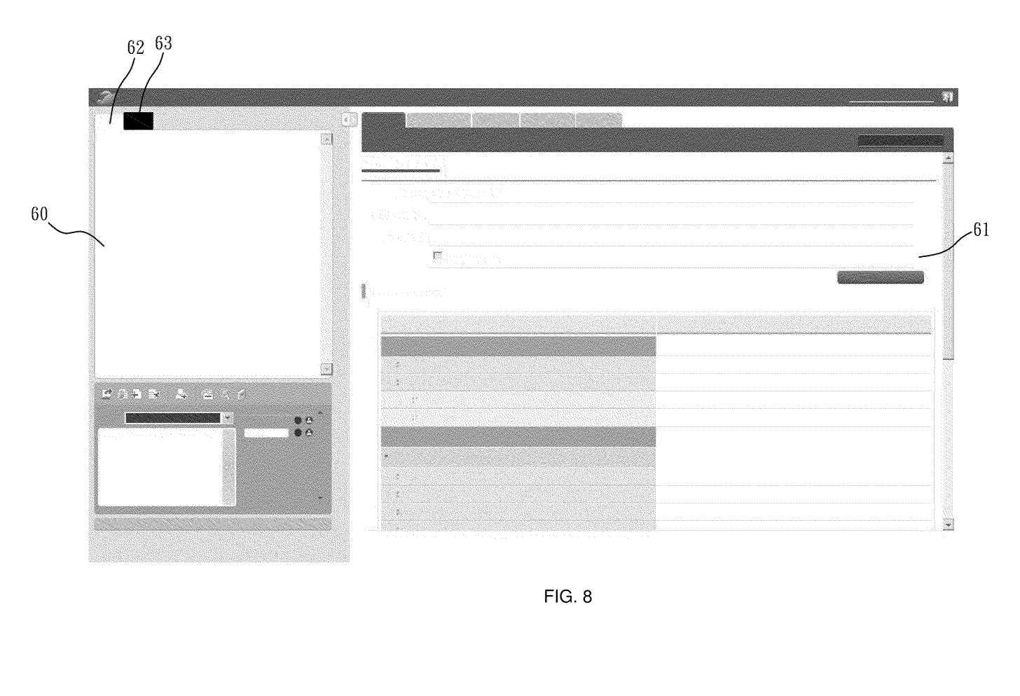

Referring to FIG. 8, when the business client clicks the Partner 48 window interface, and the business partner initiates and invites the business client to participate in the partner's activity, or when the business client clicks the Activity 49 window interface, and the business partner initiates and invites the business client to participate in the partner's activity or the business activity created by the business client itself, the system will open a window, which enables the Conversation Module 14 to perform the switching of letter messages, and the Collaborative Application Module 11 to conduct collaborative business activity.

The window interface in FIG. 8 depicts only a preferred embodiment of the present invention, which is not covered in the range of the present invention. This window interface can be divided into left-hand Conversation Interface 60 for letter messages and right-hand Collaborative Interface 61; the business activities of Collaborative Interface 61 include: Generate Product Phase 51, Set up Component and Attribute 52, Set up Material and Specification 53, Set up Variation 54, Set up Pack Detail 55 and/or Invite Business Partner 56 as also shown in FIG. 7; during the process of Create Activity 50, the settings of unfinished contents can be set in the Collaborative Interface 61, while the redefined contents, modified, saved, committed, aborted or added contents will be displayed on the Conversation Interface 60 of the business client and the participating partner; if the business client sets all participating partners into a Shared Mode 62, and the Conversation Interface 60 is under the window of Shared Mode, the letter display can be viewed by all participating partners; if the business client sets the participating partners into an Exclusive Mode 63, unless the business client switches the Conversation Interface 60 to exclusive participating partners, these exclusive participating partners cannot access to any message on the Conversation Interface 60; the business client can also set all participating partners into an Exclusive Mode 63, the participating partners set into the Exclusive Mode 63 cannot know who participate in the business activity created by the business client; only the participating partners set into Shared Mode 62 get to know who participate in the business activity created by the business client, but do not know the existence of participating partners set into the Exclusive Mode 63. The Conversation Interface 60 also permits to implement the functions of inviting the partners to participate, uploading files/documents, sending by attachments and/or real-time conversation.

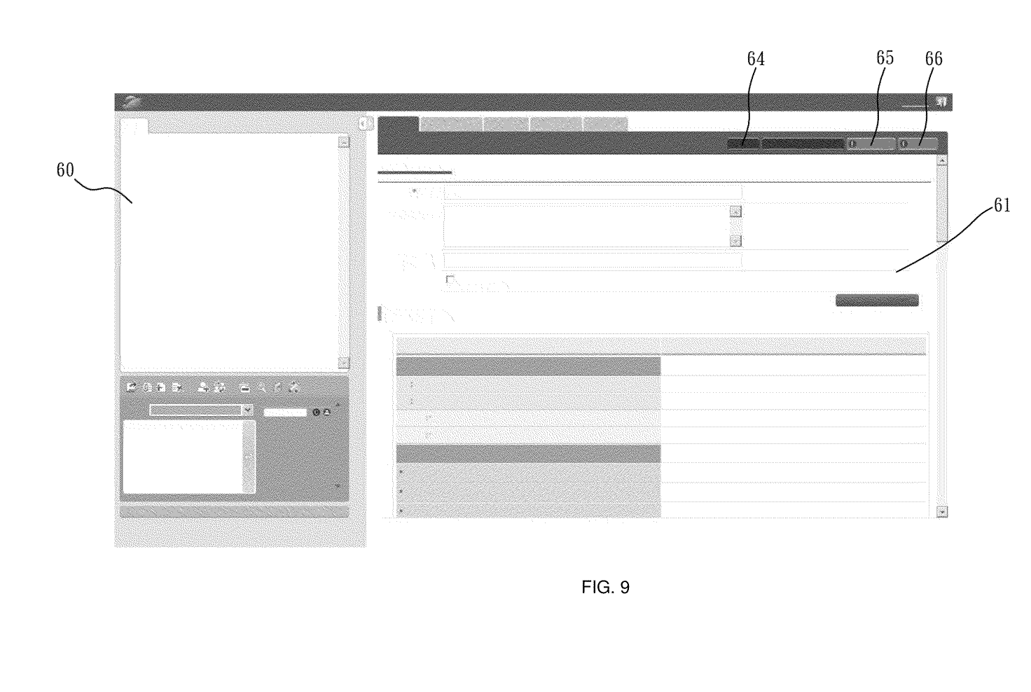

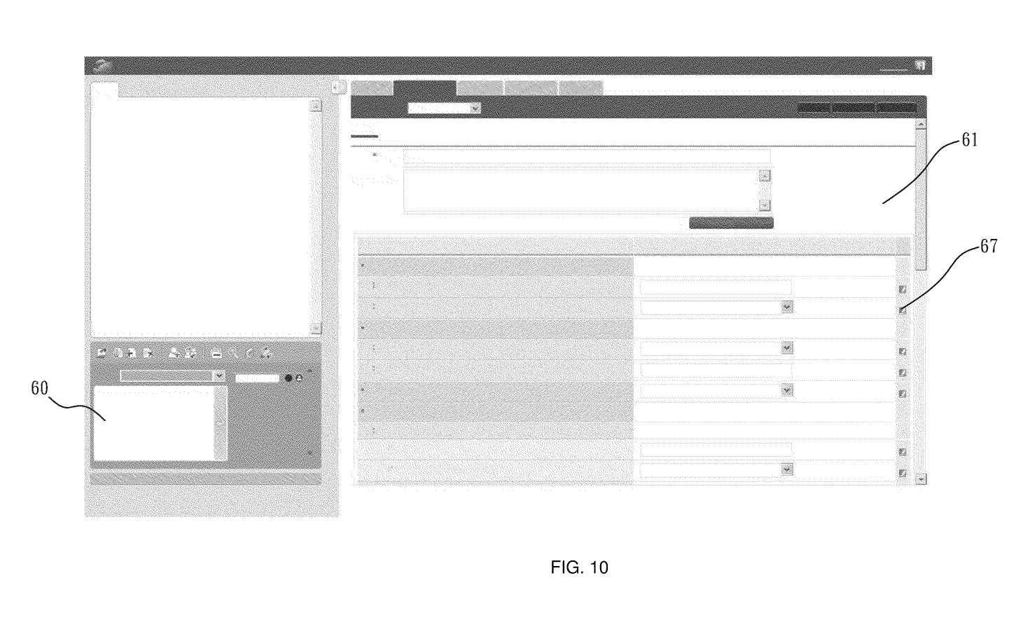

Of which, the Collaborative Interface 61 only permits the initiator of the business activity to set, add, modify, save 64, commit 65 and/or abort 66 the contents at various phases, as shown in FIG. 9; meanwhile, the business partner for this business activity will update the status of Collaborative Interface 61; referring to FIG. 10, if the participating partner thinks some settings in the Collaborative Interface 61 are not implemented at certain phase, he/she may click the content field to open a new message sending window and enter the contents (e.g. recommended size or material); with the Post-it Module 15, the Message 67 is displayed on the Collaborative Interface 61 created by the business client and initiator, where the image is represented by yellow notes. As the yellow notes not yet read will be in a flashing status, the business client may click this note to read and modify the settings specific to this phase; after all settings of all phases are confirmed, he/she may click Commit 65 as shown in FIG. 9, so entire business activity is committed on-line to the partner for actual operation, or click Abort 66 to cancel the on-going business activity or click Save 64.

To sum up, the collaborative business methods and its implementation system of the present invention can really realize the aforementioned efficacies as disclosed in the preferred embodiments, and the patent application is not yet made publicly available, so it conforms to the requirements of novelty and applicability of utility model.

Although the invention has been explained in relation to its preferred embodiment, it is to be understood that many other possible modifications and variations can be made without departing from the spirit and scope of the invention as hereinafter claimed.

I claim:

1. A collaborative method, which is designed for conducting business activities with the partner in a trust environment; trust-based business community (TBC) model is defined as follows:
a. a trust-based business community(TBC) is a group of trusted Business Persons (BP) formed by invitations to conduct meaningful Collaborative Activities; every Business Person is trusted and invited by at least one Business Person or the initiator of the community; whether a business person is “trusted” solely depends on whether the inviting party can trust the person or not. It is the sole responsibility of the inviting party to verify the trust relationship;
b. a Business Persons (BP) is an individual who works as a specific role (function) for a specific corporation;
c. a Business Person's status is invalidated as soon as he/she changes his current position;
d. it is the responsibility of every Business Person to reveal his/her job position change to other Business Person in the TBC;
e. once a Business Person is invalidated, he/she may not be trustworthy; the new trust state of the individual is determined and should be reviewed by his/her Business Persons;
f. a TBC starts with an initiator Business Person who invites other trusted Business Persons from the real business world; any Business Person in the TBC can then invite more trusted Business Persons; this trust-based invitation process produces a group of trusted Business Persons, which forms a trust-based business community;
g. an invitation is a message-based process; an invitation is initiated by a Business Person and accepted or denied by a second Business Person;
h. the fact that A trusts B implies that B trusts A; it is the sole responsibility of the inviting party to verify the trust relationship;
i. the (directly) invited Business Person and the inviting Business Person are known as Partners; the fact that A is a partner of B implies that B is a partner of A; any indirect invitation does not establish a partnership. For example, A invites B and B invites C. A and B are partners. B and C are partners. But, A and C may NOT be partners; the fact that A trusts B as B trusts C does not imply that A trusts C;
j. a Business Person can terminate a partnership by un-inviting the partner; a partnership can only be terminated successfully only if no on-going activities exist;
k. a Collaborative Activity is an activity created by a Business Person (called the Chairman or Creator), who invites one or more Business Persons as the participants to play interactively according to the rules and processes pre-defined in the Collaborative Activity; any participant can invite his/her partners to participate the activity; two participants of a Collaborative Activity may not be partners;
l. an invitation to a Collaborative Activity is a message-based process, which is initiated by a participant and accepted or denied by a partner;
m. a Collaborative Activity starts when the chairman creates the activity, and ends when the chairman commits or aborts the activity;
n. when a Business Person is invalidated, he/she can not access to all Collaborative Activities that he/she created or participated.

2. The method defined in claim 1, wherein the creator of the business activity can specify the participating modes for the participants accepted; there are two participating modes: Shared and Exclusive;
a Shared participant knows the existence of all participants (both Shared and Exclusive) and is able to see all the actions or data issued from all participants (both Shared and Exclusive); an Exclusive participant knows the existence of only Shared participants and is able to see the actions or data only from Shared participants; an Exclusive participant does not know the existence of any other Exclusive participant, and is not able to see actions or data from any other Exclusive participant.

3. A system for achieving the collaborative business method, wherein the business client can login the Internet to conduct mutual invitation through this system, create the business activity, implement collaborative jobs and formulate business decisions; this system comprises:
Platform API, Partner Module, Activity Module, Conversation Module, Post-it Module and Collaborative Application Module;
Partner Module 12 is responsible for management of the business partners' information, searching the business partners, viewing real-time change message of business partners, management of other invited business partners and/or message management of business partners;
Activity Module 13 is responsible for creating and managing the business activities, participating in the business activities created by other business persons (BP), searching/screening the business activities and/or viewing real-time message related to the business activities;
Conversation Module is responsible for real-time message communication among business persons (BP) when participating in the collaborative business activities.

4. The system defined in claim 3, wherein the system further comprises:
Post-it Module is responsible for implementing the notes and remarks during collaborative application.

5. The system defined in claim 3, wherein the system further comprises:
Collaborative Application Module, allowing the business client to set the business application of business logic according to business requirements.

6. The system defined in claim 5, wherein the Collaborative Application Module further comprises CAP database, allowing data access among Collaborative Application Product Modules.

7. The system defined in claim 5, wherein the Collaborative Application Product Module further comprises ebXML Registry, which delivers an interface to Business Persons (BP) for integrating their own data when participating in the collaborative business applications.

8. The system defined in claim 4, wherein the Post-it Module further comprises Post-it Database, allowing for data access among Post-it Modules.

9. The system defined in claim 3, wherein Partner Module, Activity Module and Conversation Module further comprise Platform Database, allowing for data access by Partner Module, Activity Module and Conversation Module.

10. The system defined in claim 3, wherein this system is also responsible for sending information to the business client by an e-mail through a mail server.

11. The system defined in claim 3, wherein the system is a graphical and literal windowing operational interface or a combined operational interface.

12. A method for achieving the collaborative business model, wherein the Business Persons (BP) (a user assuming the responsibility for the company) invite the business partners in a trust environment, and assist in creating collaborative activities, performing collaborative processes and real-time tracking control to realize the mutual objectives.

13. The method defined in claim 12, wherein the business person can login a system through Internet, and then invite the business partner for a specific business activity, create business event, conduct collaborative jobs for the business event and formulate the final business decisions to help the business partners conduct collaborative business activities under a trust environment.

14. The method defined in claim 12, wherein the method includes:
obtain a group of account and password: after company request and invitation by other Business Persons (BP), enter into the registry mode to create Business Persons (BP);
login: login the system according to the selected mode corresponding to the account and password;
confirm company name: after login, the system permits the business client to confirm the company name;
partner/activity: after confirmation of company name, login the “partner” and “activity” window interfaces delivered by the system;
invite partner;
create activity;
conduct collaborative business activities.

15. The method defined in claim 14, wherein Create Business Persons (BP) requires for data input, and then implements finishing registry procedure after data confirmation; if data confirmation is not yet completed, the system will require the business client to conduct data input again and fill in unfinished information or field, until the system conducts data confirmation and finishing registry procedures.

16. The method defined in claim 15, wherein the information confirmed by the data delivery system include but not limited to the names, email addresses, liaison persons and passwords.

17. The method defined in claim 15, wherein after completion of finishing registry procedure, the system feeds back a confirmation email to the email address delivered by the business client, who receives the email and starts the account and password.

18. The method defined in claim 14, wherein the business person Creates Business Persons (BP) by the registry mode of corporation, the corporation account allows to manage the business persons according to the operational interface delivered by the partner module, including but not limited to: setting of authority, agency of business persons, deletion and/or replacement.

19. The method defined in claim 14, wherein the business person Creates Business Persons by the registry mode invited by the business persons, it is possible to manage the personal information according to the operational interface delivered by the system, including but not limited to: revision of information.

20. The method defined in claim 14, wherein the login steps include:
start: if connecting to the system's login webpage through Internet, the system will display an account and password entry box;
enter account and password: enter account and password in the window opened by the preceding step;
login: after entering the account and password in the preceding step, click login button;
confirm account and password: judge the account and password by the system.

21. The method defined in claim 20, wherein the system judges the account and password; in the case of error of the password corresponding to the account, re-enter in the password field and then select login button; or select password omission button in the window, then the system feeds back the password of modified account to the e-mail registered by the business person, so as to obtain the correct password.

22. The method defined in claim 14, wherein the account allows to set an email address; the password may be composed of English letters and figures.

23. The method defined in claim 14, wherein the company name confirmation means the company name can be modified or changed since the business client has resigned from original company, or original company has changed its name.

24. The method defined in claim 14, wherein the partner window interface includes: invite, uninvite, message, logout, search, event and message, information, partner view and/or company view buttons.

25. The method defined in claim 14, wherein the partner window interface includes: photo, status, user name, company name, job title, activity and/or channel fields.

26. The method defined in claim 24, wherein the partner interface comprising:
Invite: if selecting this button, the system will login this window. This window interface includes: name of the invitee, company name, input of email box field, search of registered company name, input/invite buttons of inviter's self-description field; users can invite the other party if selecting Invite button after completion of entry; and, the system will send a message to the invitee, who becomes a business partner if accepting the invitation, otherwise refuses feedback of the message;
Uninvite: select the invited business partner, click Uninvite button to remove the business partner from the partner window; it is imperative that the partner has not attended the activity created by the inviter before being uninvited, or has been removed from the list of attendee by the inviter;
Message: select the invited business partner, click Message button to login this window, which includes subject and message fields; the business person can write subject and the message to be told, and then click Notify button, so the message can be sent to the selected business partner through the system;
Search: the business person clicks Search button to login this window, which is available with an entry field for entering the character or character string to be searched; at the same time, it provides the settings of search conditions, including: nickname, company, last name, first name and Boolean operation;
Event and message: the business person receives the sent messages, or some procedures implemented by the business client, e.g.: creation of activity or invitation of the business partner, etc; then, the system will remind of having received new events or messages; the business person can login this window by clicking Event and Message button; the window includes event interface and/or message interface;
Information: providing the functions of viewing the information of the business client and successfully invited business partner;
Partner view: the system presets that the real-time status of business partner is sequenced on top priority, followed by user name, company name, activity and channel;
Company view: the system presets that status of business partner is sequenced on top priority, followed by company name, user name, job title, activity and channel;
Logout: click logout button, then the system performs logout.

27. The method defined in claim 26, wherein the status field displays the inviting status of business partner, invited status, off-line or on-line status; the user name, company name and job title fields display the real name of business partner, real company name and actual job title; the activity field displays the business activity created by the business partner; and the channel field shows if the business partner provides Internet telephone (skype).

28. The method defined in claim 26, wherein the Business Persons (BP) may click information or the user name of business partner, then the system will open a window, which includes: information, personal, company and/or note; of which, the “information” displays e-mail, company name, user name, job title, time zone, set password and/or upload photos; the “personal” displays contact number, address, city, state and country; the “company” displays department, contact number, fax number, address, city, state and country; the “note” displays the description field, which can be entered, modified or set and saved, or cancelled by clicking Cancel button; the information of business partner is only for viewing, but cannot be written or modified, and the password is hidden.

29. The method defined in claim 26, wherein the event interface provides the settings of screening conditions, including: all, notify, receive, accept, reject, invite, uninvite, update, update company, overdue, create, participate, un-participate, commit and/or abort; while the displayed field includes mark field, time of event, type of event and/or information; the Business Person (BP) or the business partner performs the relevant system processes, and the system generates the event mark in real-time manner; after viewing the new event marks, the Business Persons (BP) may remove the mark of new event by clicking “mark as done” button.

30. The method defined in claim 26, wherein the message interface provides the settings of sequencing, including: time, sender and/or subject; while the displayed field includes: mark field, time of message, sender, subject and/or information; the business person can then click the subject to login this window displaying the details of the message; after viewing the details, the business person may close the window by clicking “Close” button, or cancel this message by clicking “Cancel” button.

31. The method defined in claim 14, wherein the activity window interface includes: create, logout, search activity, activity log and/or information buttons.

32. The method defined in claim 31, wherein this window comprising:
Create: if clicking Create button, a business activity could be established through the system;
Search activity: if clicking Search button, the system will open a window, which provides an entry field for entering the character or character string of the activity to be searched;
Activity log: the business client receives the sent messages, or some procedures implemented by the business client, e.g.: requiring the partner to participate in the created business activity or cancelling the partner to participate in the created business activity, or the partner is invited by the remote inviter to participate in the created business activity as well as creation of activity, etc; the system reminds of having received new logs or messages, so the business person can open a window by clicking the Activity Log button; this window includes history interface and commit/abort interface;
Information: this Activity window interface provides the functions of viewing the information of the business client and the business partner in the business activity;
Logout: this Activity window interface provides the business client with a function of exiting from this window by clicking logout button.

33. The method defined in claim 32, wherein the history interface provides the setting of the screening conditions, including: all, create, participate, un-participate, request, block, replacement and remove; the displayed field includes mark field, time of history log, type of log and/or information; after viewing the new history log, the business client may remove the mark of new log by clicking “mark as done” button.

34. The method defined in claim 32, wherein the commit/abort interface provides the settings of sequence, including: all, status, activity, creator and type; the displayed field includes: mark field, time, name of activity, creator, company and/or type; after viewing the logs of new commit or abort, the business client may remove the mark of new log by clicking “mark as read” button.

35. The method defined in claim 14, wherein the system will open a window after clicking Create Collaborative Business Activity, while setting a series of business activity planning and conditions.

36. The method defined in claim 35, wherein the business planning includes: generate product phase, set up component and attribute, set up material and specification, set up variation, set up pack detail and/or invite business partner.

37. The method defined in claim 36, wherein this plans includes:
generate product phase: the setting in this phase includes: set the program name, type, icon, product name, description, attachment and/or category;
set up component and attribute: the setting in this phase includes: set the components of product and their attributes;
set up material and specification: the setting in this phase includes: set the materials for the components of product and their attributes, and set the specification and/or manufacturing process;
set up variation: the setting in this phase includes: set the changing styles, sizes and colors of products;
set up pack detail: the setting in this phase includes: description of instruction, mode of payment, type of currency, shipping mode, delivery date, contrast of sizes and/or setting of style, sizes and quantities, etc;
invite business partner: the setting in this phase includes: invite the business partner to participate in the created activity program, set the power of partners participating in this program, and set the shared or exclusive modes of partners participating in this program.

38. The method defined in claim 14, wherein the collaborative business activity means the system will open a window for collaborative business activity, when the business client clicks the partner window interface, and the business partner initiates and invites the business client to participate in the partner's activity, or when the business client clicks the Activity window interface, and the business partner initiates and invites the business client to participate in the partner's activity or the business activity created by the business client itself.

39. The method defined in claim 38, wherein the windows opened by the system can be divided into left-hand Conversation Interface for letter messages and right-hand Collaborative Interface.

40. The method defined in claim 39, wherein the business activities of the Collaborative Interface include: generate product phase, set up component and attribute, set up material and specification, set up variation, set up pack detail and/or invite business partner.

41. The method defined in claim 40, wherein the settings of unfinished contents can be set in the Collaborative Interface during the process of Create Activity; while the redefined contents or added contents will be displayed on the Conversation Interface of the business client and the participating partner.

42. The method defined in claim 41, wherein the business client can set all participating partners into Share or Exclusive mode.

43. The method defined in claim 41, wherein the business client can set some participating partners into Share mode, and some participating partners into Exclusive mode.

44. The method defined in claim 39, wherein The Conversation Interface permits to implement the functions of inviting the partners to participate, uploading files/documents, sending by attachments and/or real-time conversation.

45. The method defined in claim 39, wherein the Collaborative Interface only permits the initiator of the business activity to set, add, modify, save, commit and/or abort the contents at various phases; meanwhile, the business partner for this business activity will update the status of Collaborative Interface.

46. The method defined in claim 45, wherein the participating partner may click the setting content field to open a new message sending window, which requires to enter the letter contents and then send them; while the message is displayed on the Collaborative Interface created by the business client and initiator; after reading the contents, the business client may modify the settings specific to this phase; after all settings of all phases are confirmed, the business client may click Commit button, so entire business activity is committed on-line to the partner for actual operation, or click Abort to cancel the on-going business activity or click Save to save the business activity.

47. The method defined in claim 13, wherein it is possible to access to the system by any electronic device or equipment, such as: desktop computer, notebook computer, PDA and mobile phone, etc, whichever can linked to the Internet.

48. The method defined in claim 32, wherein the business client may click Information button or the pull-down key to display them in the field uploaded by the business partner; after clicking the user name of the business partner, the system opens a window including: information, personal, company and/or note; of which, the “information” displays e-mail, company name, user name, job title, time zone, set password and/or upload photos; the “personal” displays contact number, address, city, state and country; the “company” displays department, contact number, fax number, address, city, state and country; the “note” displays the description field, which can be entered, modified or set and saved, or cancelled by clicking Cancel button; the information of business partner is only for viewing, but cannot be written or modified, and the password is hidden.

49. The method defined in claim 32, wherein the activity window interface includes: mark field, pull-down key, representative photo of the activity, activity name, option button of “acceptance” and “refusal”, and type of activity, etc; while the created and participated business activity will be displayed by different colors in the field.

50. The method defined in claim 49, wherein the mark field can display if the created business activity is finished (without participant, or not yet joined by participant), and block activity mark.

51. The method defined in claim 50, wherein the blocked activity mark is generated owing to the fact that the business activity participated or created by original company is blocked due to the change of business client's company name; if the company name is modified during login, the business activity created or participated will not be blocked.

52. The method defined in claim 32, wherein the business activity is provided with pull-down key, allowing to view the participant of the business activity; the field of participants displays the photos uploaded by the business partner, off-line or on-life status of business partner, business partner name and/or company name.
